(19) United States
(12) Patent Application Publication
(10) Pub. No.: US 2013/0128128 A1
(43) Pub. Date: May 23, 2013

(54) LIGHTING DEVICE, DISPLAY DEVICE AND TELEVISION DEVICE

(71) Applicant: Kaori Ikuta, Osaka-shi (JP)

(72) Inventor: Kaori Ikuta, Osaka-shi (JP)

(73) Assignee: SHARP KABUSHIKI KAISHA, Osaka-shi, Osaka (JP)

(21) Appl. No.: 13/812,948

(22) PCT Filed: Jun. 20, 2011
(86) PCT No.: PCT/JP2011/064040

§ 371 Date: Jan. 29, 2013

(30) Foreign Application Priority Data
Jul. 30, 2010 (JP) 2010-172402

(51) Int. Cl. F21V 7/00; G02F 1/1335

(52) U.S. Cl. CPC F21V 7/0066; G02F 1/133605
USPC 348/790; 362/97.1; 349/67

(57) ABSTRACT

A backlight unit includes a chassis including a bottom plate and side plates rising toward a front side with an opening on a front side, LEDs housed in the chassis, an optical member arranged on an opening side of the chassis and through which light from the LED passes, a reflection member including inclined surfaces configured to lead the light from the LED toward the optical member, and a support pin attached to the bottom plate of the chassis and extending from an LED mounting surface toward the optical member such that a tip end of the support pin is in contact with the optical member to support it. The support pin is arranged between the LEDs and equally away from each of the LEDs.

### TECHNICAL FIELD

The present invention relates to a lighting device, a display device, and a television device.

### BACKGROUND ART

In recent years, a display element of an image display device such as a television device is shifting from a conventional CRT display device to a thin display device using a thin display element such as a liquid crystal panel and a plasma display panel. This enables the image display device to have a reduced thickness. A liquid crystal panel used for a liquid crystal display device does not emit light, and thus a backlight unit is required as a separate lighting device.

As the backlight unit, a direct-type backlight unit that supplies light directly to a liquid crystal panel from its rear side is known. In such a backlight unit, a reflection member may be provided on a mounting surface on which light sources such as LEDs are arranged. Further, an optical member may be provided between the light sources and the liquid crystal panel to provide predetermined optical characteristics to the light passed through the optical member.

Patent Document 1 discloses a reflection member used in a direct-type backlight unit, for example. The reflection member has a three-dimensional shape including inclined surfaces inclined from the mounting surface on which the LEDs are mounted toward the liquid crystal panel. By the employment of such a reflection member in the direct-type backlight unit, light emitted from the LEDs can be led toward the liquid crystal panel side by the inclined surfaces of the reflection member, and thus uneven brightness on a display surface of the liquid crystal panel can be prevented or suppressed.

### RELATED ART DOCUMENT

### Patent Document

Patent Document 1: Japanese Unexamined Patent Publication No. 2008-292991

### Problem to be Solved by the Invention

If the above-described direct-type backlight unit including the reflection member disclosed in Patent Document 1 employs the optical member, a support member is required to be provided on the mounting surface on which the LEDs are arranged to support the optical member from below. In such a case, a part of the light traveling from the LEDs toward the reflection member may be blocked by the support member. This may lead uneven brightness on the display surface of the liquid crystal panel.

### Disclosure of the Present Invention

The present invention was made in view of the above circumstances. It is an object of the present invention to provide a technology that can prevent or suppress the uneven brightness that may be caused on the display surface by the support member in the direct-type lighting device including the reflection member configured to lead the light toward the display surface.

### Means for Solving the Problem

A technology disclosed herein relates to a lighting device including a chassis including a bottom plate and side plates rising from peripheral edge portions of the bottom plate toward a front side, a plurality of light sources housed in the chassis, an optical member arranged on an opening side of the chassis, a reflection member including a plurality of inclined surfaces inclined from a light source mounting surface on which the light sources are mounted toward the optical member, and a support member attached to the bottom plate of the chassis. The chassis has an opening on the front side. Light emitted from the light sources passes through the optical member. The inclined surfaces are configured to lead the light emitted from the light sources toward the optical member. The support member extends from the light source mounting surface toward the optical member and a tip end of the support member is in contact with the optical member to support the optical member. The support member is positioned between the light sources and spaced equally away from each of the light sources.

In the above-described lighting device, the support member arranged between the light sources is spaced equally away from each of the light sources. Accordingly, when the light traveling from the light source to the inclined surface of the reflection member is partially blocked by the support member, the light can be equally blocked. Further, the light traveling from the light source to the inclined surface of the reflection member is less likely to be blocked by the support member. Thus, in the direct-type lighting device, the uneven brightness that may be caused on the display surface by the support member can be prevented or suppressed.

The support member may be arranged to pass through the reflection member.

With this configuration, a part of the support member is covered with the reflection member, and thus the light traveling from the light source to the inclined surface of the reflection member is less likely to be blocked. This can prevent or suppress the uneven brightness that may be caused on the display surface by the support member.

The reflection member may have a top surface portion connecting optical-member-side end portions of the inclined surfaces adjacent to each other. The support member may be arranged to pass through the top surface portion.

With this configuration, a larger part of the support member can be covered with the reflection member. Thus, the light traveling from the light source to the inclined surface of the reflection member is further less likely to be blocked by the support member, and thus the uneven brightness that may be caused on the display panel by the support member can be prevented or suppressed.

The support member may include a contact portion that is in contact with a surface of the reflection member facing the optical member.

With this configuration, the lifting up of the reflection member toward the optical member can be prevented or suppressed by the contact portion of the support member. This can prevent or suppress the uneven brightness that may be caused on the display surface by the support member.

The support member may have a tapered shape. With this configuration, the area in which light emitted from the light source may be blocked by the support pin can be smaller. This can prevent or suppress the uneven brightness that may be caused on the display surface by the support member.

The support member may be arranged to pass through the bottom plate of the chassis to be attached to the bottom plate.

With this configuration, the support member can be stably fixed to the bottom plate of the chassis. Accordingly, the uneven brightness that may be caused on the display surface by the support pin can be effectively prevented or suppressed.

The reflection member may have a shape encircling each one of the light sources.

With this configuration, the light emitted from each light source can be effectively led toward the optical member by the reflection member. Thus, the uneven brightness on the display surface can be further prevented or suppressed.

The light sources may be arranged at regular intervals.

With this configuration, brightness distribution can be more equalized on the light exit side of the light source. Thus, the uneven brightness on the display surface can be prevented or suppressed.

The technology disclosed herein may be embodied as a display device including a display panel configured to display by using light provided by the above lighting device. Further, a display device including a liquid crystal panel using liquid crystals as the display panel has novelty and utility. Furthermore, a television device including the above display device has novelty and utility. The above display device and television can have an increased display area.

### Advantageous Effect of the Invention

According to the technology disclosed herein, in the direct-type lighting device including the reflection member configured to lead the light toward the display surface, the uneven brightness that may be caused on the display surface by the support member hardly or is less likely to occur.

### BRIEF DESCRIPTION OF THE DRAWINGS

FIG. 1 is an exploded perspective view of a general construction of a television device according to the first embodiment of the present invention;

FIG. 2 is an exploded perspective view of a liquid crystal display device 10;

FIG. 3 is a plan view of the backlight unit 24;

FIG. 4 is a cross-sectional view of the backlight unit 24;

FIG. 5 is a cross-sectional view of the backlight unit 24;

FIG. 6 is a magnified plan view of an area around a support pin 27 included in the backlight unit 24;

FIG. 7 is a plan view of a backlight unit 124 according to a second embodiment;

FIG. 8 is a plan view of a backlight unit 224 according to a third embodiment; and

FIG. 9 is a cross-sectional view of the backlight unit 224.

### MODE FOR CARRYING OUT THE INVENTION

### First Embodiment

The first embodiment of the present invention will be described with reference to drawings. An X-axis, a Y-axis, and a Z-axis are described in a part of the drawings, and a direction of each axis corresponds to that of the respective axes in other drawings. The Y-axis direction corresponds to a vertical direction and The X-axis direction corresponds to a horizontal direction.

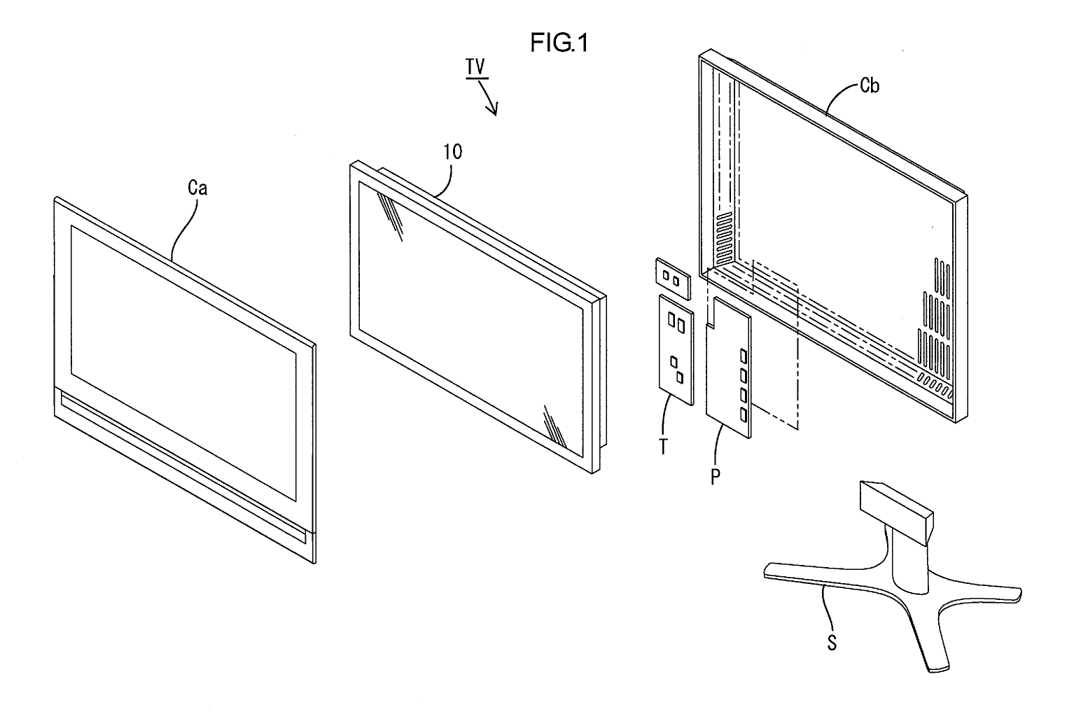

FIG. 1 illustrates a television device TV according to the first embodiment in an exploded perspective view. As illustrated in FIG. 1, the television device TV includes a liquid crystal display device 10, front and back cabinets Ca and Cb, a power supply P, a tuner T, and a stand S. The front and back cabinets Ca and Cb sandwich, and thus house, the liquid crystal display device 10. The liquid crystal display device 10 has a landscape quadrangular shape as a whole and held in the vertical position.

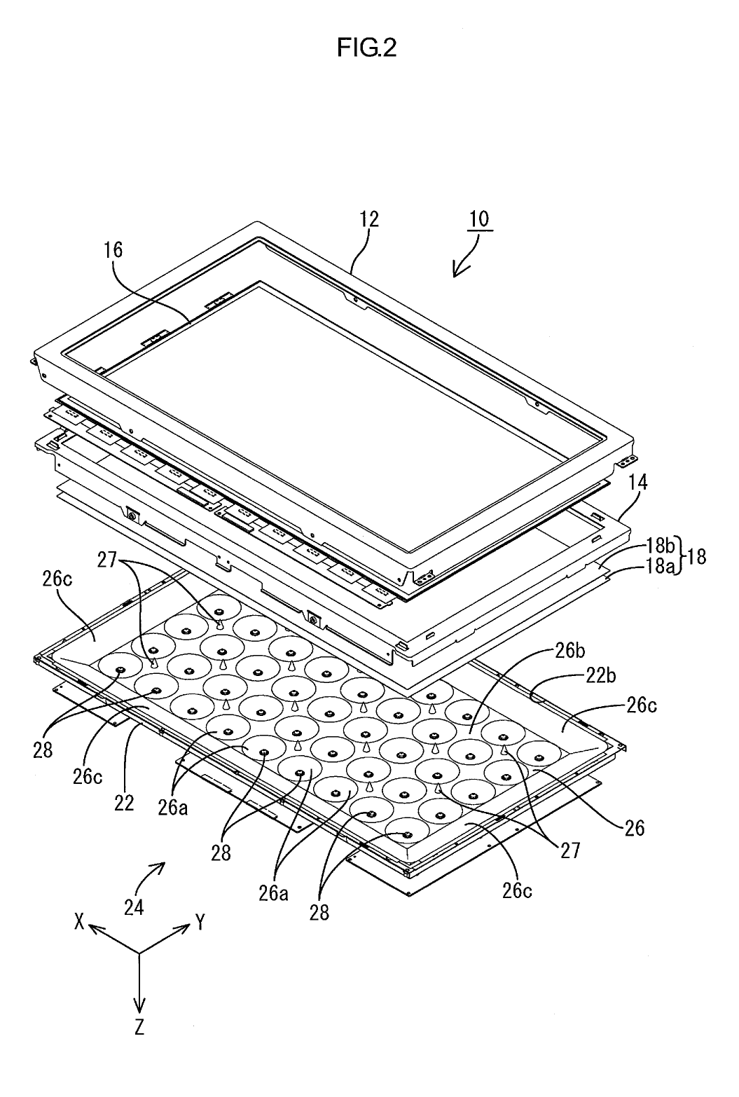

FIG. 2 illustrates the liquid crystal display device 10 in an exploded perspective view. Herein, an upper side in FIG. 2 corresponds to a front side, and a lower side therein corresponds to a rear side. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (high light transmissive) glass substrates is bonded together with a predetermined gap therebetween and a liquid crystal layer (not illustrated) is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrode, an alignment film, and the like are provided. Image data and control signals that are necessary to display an image are sent to the source lines, the gate lines, and the counter electrodes, from a drive circuit substrate, which is not illustrated. Polarizing plates (not illustrated) are arranged on outer surfaces of the glass substrates.

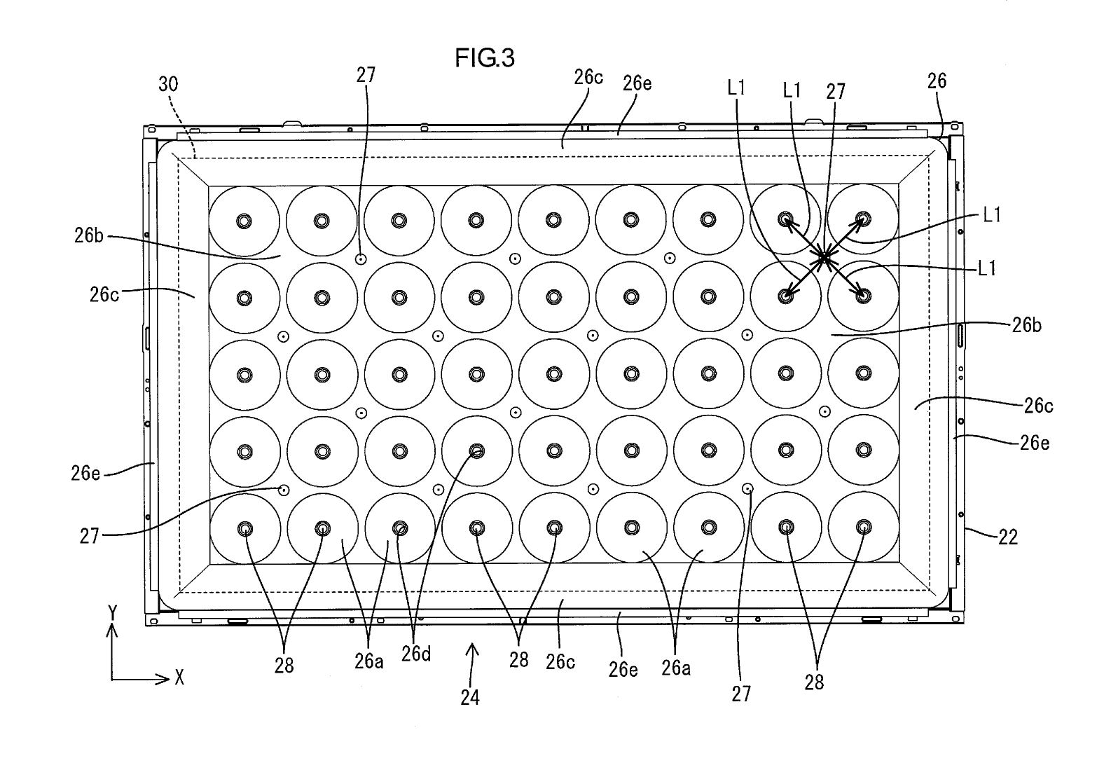

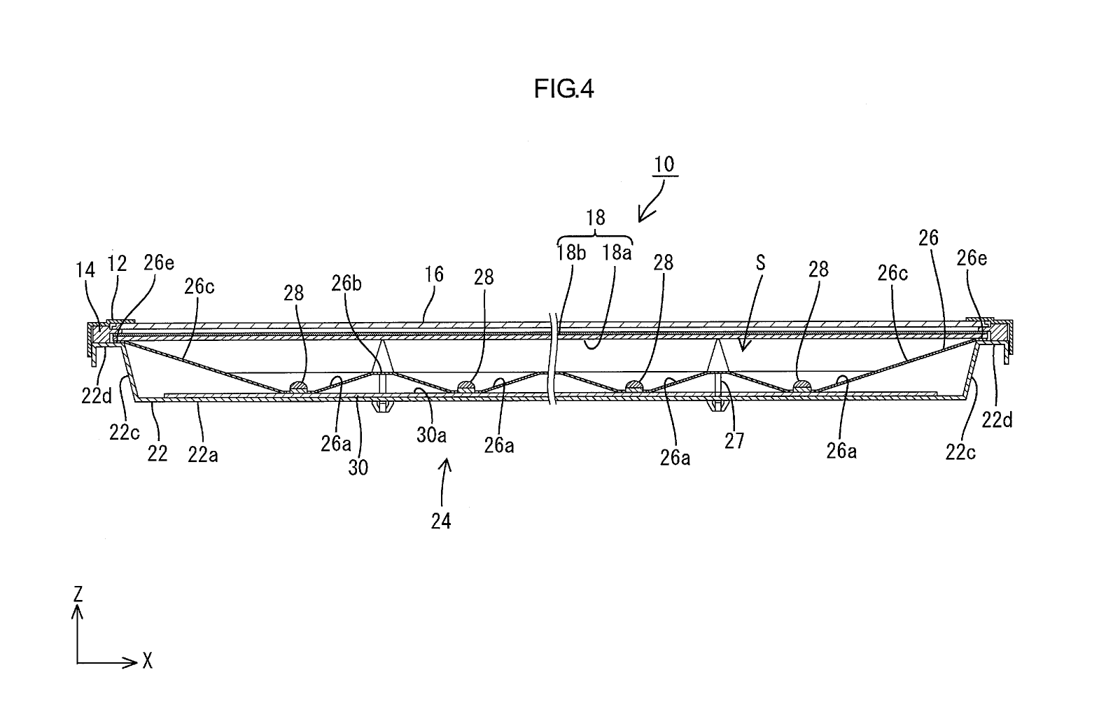

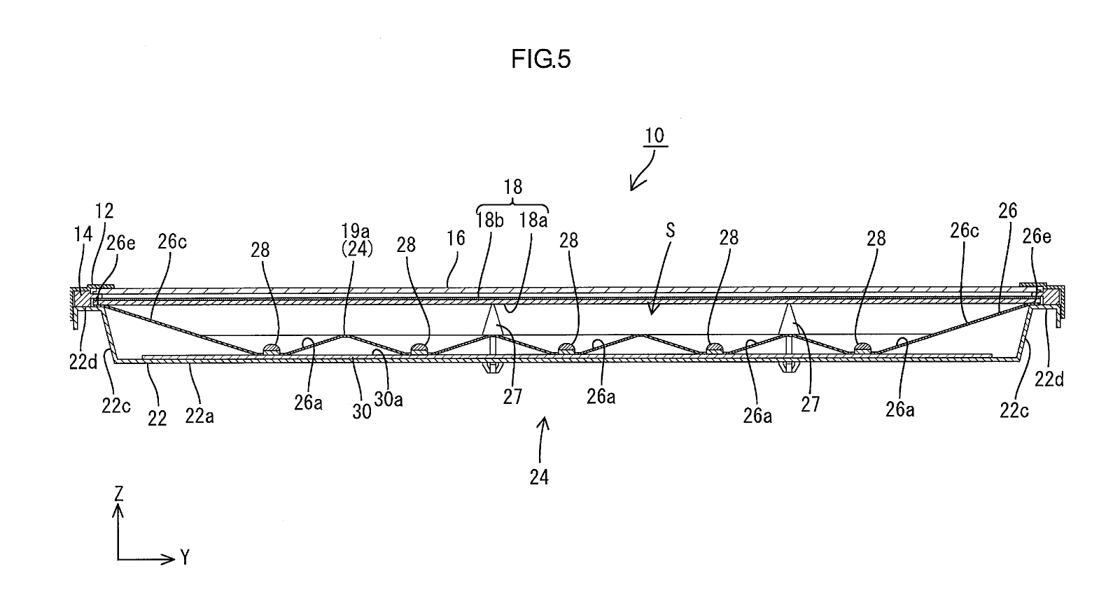

The backlight unit 24 will be explained. FIG. 3 illustrates the backlight unit 24 in a plan view. FIG. 4 illustrates the backlight unit 24 in a cross-sectional view taken along the horizontal direction (the X-axis direction). FIG. 5 illustrates the backlight unit 24 in a cross-sectional view taken along the vertical direction (the Y-axis direction). As illustrated in FIG. 2, the backlight unit 24 includes a chassis 22, an optical member 18, and a frame 14. The chassis 22 has a substantially box-like shape with an opening on the front side (a light exit side, the liquid crystal panel 16 side). The optical member 18 is provided on the front side of the chassis 22 so as to cover the opening thereof. The frame 14 has a frame-like shape and supports the liquid crystal panel 16 along its inner edge.

The chassis 22 houses an LED board 30, a reflection member 26, and a plurality of support pins 27. A plurality of point-like LED (Light Emitting Diode) light sources 28 are arranged on the LED board 30 (see FIG. 4 and FIG. 5). The support pins 27 support the optical member 18 from its rear side such that the optical member 18 is not deformed toward the LED light source 28, for example. Each support pin 27 extends from the LED board 20 side to the optical member 18 side through the reflection member 26. The tip end of the support pin 27 is in contact with a rear surface of the optical member 18 to support the optical member 18. In the backlight unit 24, the side closer to the optical member 18 than the LED board 30 side is a light exiting side. Namely, the backlight unit 24 is a direct-type backlight unit in which light is directly applied to the liquid crystal panel 16 from its rear side through the optical member 18.

The chassis 22 is made of metal such as aluminum. The chassis 22 includes a bottom plate 22a, side plates 22c and receiving plates 22d. The entire shape of the chassis 22 is substantially a shallow box-like shape (substantially a shallow dish shape). The bottom plate 22a has a landscape rectangular shape like the liquid crystal panel 16. The bottom plate 22a is arranged on the rear side of the LED board 30, i.e., on the side opposite to the light exit side of the LED light source 28. The side plates 22c each rise from an outer edge of each side of the bottom plate 22a. The receiving plates 22d each protrude outwardly from a tip end portion of each side plate 22c. The optical member 18 and the frame 14 can be placed on a front surface of the receiving plate 22d. The frame 14 is fixed to the receiving plate 22d with screws. The long-side direction of the chassis 22 matches the X-axis direction (the horizontal direction) and the short-side direction thereof matches the Y-axis direction (the vertical direction).

Then, the LED board 30 and the LED light sources arranged on the LED board 30 will be explained. As illustrated in FIG. 4 and FIG. 5, the LED board 30 has a landscape rectangular plate-like shape like the bottom plate 22a of the chassis 22. The LED board 30 is arranged on a front side of the bottom plate 22a of the chassis 22 such that long-side direction of the LED board 30 matches the X-axis direction and the short-side direction thereof matches the Y-axis direction. The LED board 30 has a size that can cover substantially the entire area of the bottom plate 22a, specifically, most middle area other than outer peripheral area of the bottom plate 22a.

As illustrated in FIG. 4 and FIG. 5, the LED light sources 28 are mounted on a surface 30a of the LED board 30 and has a hemispherical front surface. As illustrated in FIG. 3, the LED light sources 28 are arranged in a plan on the LED board 30 along the X-axis direction and the Y-axis direction. The LED light sources 28 are arranged along each of the X-axis direction and the Y-axis direction at regular intervals. The LED light sources 28 are mutually connected by a wiring pattern (not illustrated) on the LED board 30. To the LED light sources 28, driving power is supplied by a power circuit board (not illustrated) attached on a rear side of the bottom plate 22a of the chassis 22.

The LED light sources 28 are configured to emit white light. The LED light sources 28 each may be configured by mounting a red LED chip, a green LED chip, and a blue LED chip (not illustrated) on its surface. Alternatively, the LED light sources 28 each may include a blue light emitting diode covered with a phosphor having a light emitting peak in a yellow range to emit white light. Alternatively, the LED light sources 28 each may include a blue light emitting diode covered with phosphors having a light emitting peak in a green range and in a red range to emit white light. Alternatively, the LED light sources 28 each may include a blue light emitting diode covered with a phosphor having a light emitting peak in a green range and a red light emitting diode. Alternatively, the LED light sources 28 each may include a blue light emitting diode, a green light emitting diode, and a red light emitting diode to emit white light. Alternatively, the LED light sources 28 each may include an ultraviolet light emitting diode and phosphors. Particularly, the LED light sources 28 may include an ultraviolet light emitting diode covered with phosphors each having a light emitting peak in a blue range, a green range, and a red range to emit white light.

The reflection member 26 is made of thermoplastic synthetic resin. A front surface of the reflection member 26 has a white color that provides high light reflectivity. The reflection member 26 is arranged on the front side of the LED board 30 arranged on the front surface of the chassis 22. The reflection member 26 has a size that can cover substantially the entire area of the LED board 30. As illustrated in FIG. 2 and FIG. 3, the reflection member 26 extends along the LED board 30 and includes four rising portions 26c and four extended portions 26e. The rising portions 26c are each rise from an outer peripheral edge of the bottom portion of the reflection member 26 at an angle with respect to the bottom plate 22a of the chassis 22. The extended portions 26e each extend outwardly from the outer edge of each rising portion 26c and are placed on the receiving plate 22d of the chassis 22. Further, light source through holes 26d are formed in the bottom portion of the reflection member 26 at positions overlapping with the LED light sources 28 in a plan view. Each of the LED light sources 28 passes through each of the light source through holes 26d. The light source through holes 26d are arranged along each of the X-axis direction and the Y-axis direction so as to correspond to the positions of the LED light sources 28.

The reflection member 26 further includes a plurality of inclined surfaces 26a inclined from the LED board 20 side toward the front side (the side on which the chassis 22 opens). The inclination angles of the inclined surfaces 26a are the same. A large part of the bottom portion of the reflection member 26 except for an edge portion of the light source insertion hole 26d are projected toward the front side to obtain the inclined surfaces 26a, and the remaining part of the bottom portion of the reflection member 26 is supported by the LED board 30. Each of the inclined surfaces 26a is a curved surface extending in a circumferential direction to form an inverted conical shape. Each of the inclined surfaces 26a encircles each of the LED light source 28. The inclined surfaces 26a are configured to lead the light traveled from each LED light source 28 to each inclined surface 26a toward the front side (the optical member 18 side). The projected end portions of each inclined surface 26a are connected via a top surface portion 26b that is parallel with the front surface of the LED board 30. The inclined surfaces 26a project so as to form a predetermined space S between the projected end portions thereof and the optical member 18. The projected end portions of the inclined surfaces 26a and the optical member 18 are not in contact with each other. In the space S, light emitted from one of the LED light sources 28 encircled by one of the inclined surfaces 26a and light emitted from another one of the LED light sources 28 adjacent to the one of the LED light sources 28 can travel through the space S.

The optical member 18 is placed on the receiving plate 22d of the chassis with the extended portion 26e of the reflection member 26 therebetween. The optical member 18 is arranged parallel to the LED board 30 and covers the opening of the chassis 22. On the front side of the optical member, the liquid crystal display panel 16 is arranged. The optical member 18 includes two sheets 18a, 18b stacked with each other. The optical member 18 provides an optical effect to the light emitted from the LED light source 28 and allows the light to pass therethrough toward the outside on the front side. A diffuser sheet, a lens sheet, a reflection-type polarizing sheet, and the like may be suitably selected and used as the sheets.

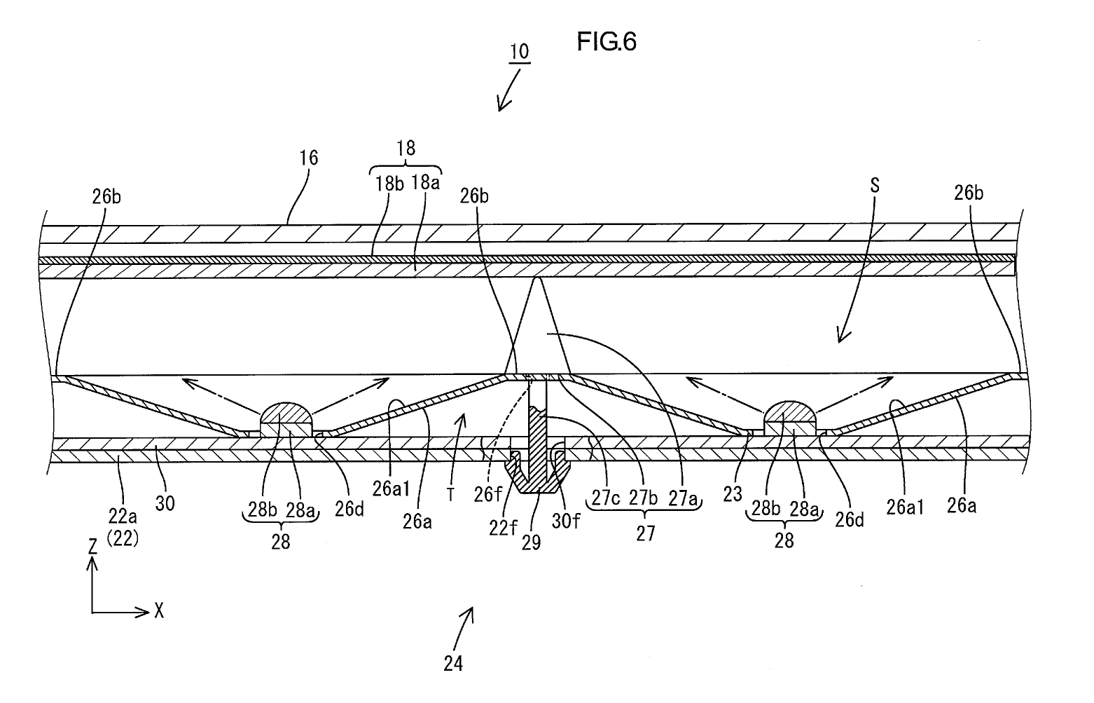

Next, the arrangement and the configuration of the support pin 27 will be explained. FIG. 6 is a magnified cross-sectional view illustrating an area around the support pin 27 of the backlight unit 24. In the backlight chassis 22, the support pins 27 are arranged. As illustrated in FIG. 3, the support pins 27 are each arranged so as to be equally away from each LED light source 28 arranged to surround the support pin 27. Further, the support pins 27 are each arranged on a position overlapping with the top surface portion 26b of the reflection member 26. Accordingly, distances L1 between each of four LED light sources 28 arranged to surround the support pin 27 and the support pin 27 are the same. The support pins 27 are each made of thermoplastic synthetic resin like the reflection member 26 and each have a white surface that can provide high light reflectivity.

As illustrated in FIG. 6, the support pin 27 includes an upper section 27a and a lower section 27c. The upper section has a conical shape tapered toward the upper side in the Z-axis direction. The lower section 27c has a shaft-like shape extending in the Z-axis direction. The upper section 27a of the support pin 27 is positioned on the front side of the top surface portion 26b of the reflection member 26 and housed in the space S. The tip end of the upper section 27a is in contact with the rear surface of the optical member 18, and thus the support pin 27 is supported. The tip end of the upper section 27a is a curved end, not a sharp end, so as not to damage the optical member 18. A lower surface 27b of the upper section 27a of the support pin 27 (corresponding to a bottom surface of the upper section 27a that is conical in shape) is in contact with the front surface of the top surface portion 26b of the reflection member 26. Accordingly, the top surface portion 26b of the reflection member 26 and the entire reflection member 26 cannot be lifted toward the front side.

The lower section 27c of the support pin 27 is positioned on the rear side of the top surface portion 26b of the reflection member 26. The lower section 27c is housed in a space T surrounded by the top surface portion 26b of the reflection member 26 and the inclined surface 26a extending from the top surface portion 26b. An upper end portion of the lower section 27c extends from the upper section 27a through an opening 26f formed in the reflection member 26. The opening 26f is formed in the top surface portion 26b of the reflection member 26 at a position overlapping with the lower section 27c. A lower end portion of the lower end section 27c passes through an opening 30f in the LED board 30 formed at a position overlapping with the lower section 27c and an opening 22f in the bottom plate 22a of the chassis formed at a position overlapping with the lower section 27c, and thus the lower end portion of the lower end section 27c is exposed to the rear side of the bottom plate 22a from the rear surface of the bottom plate 22a of the chassis 22. A part of the end portion of the lower section 27c is bent back toward the bottom plate 22a of the chassis 22 so as to form a cross-like shape in a plan view. The end of the end portion of the lower section 27c that is bent back is elastically stopped at the edge portion of the opening 22f in the chassis 22. Accordingly, the support pin 27 is attached and fixed to the bottom plate 22a of the chassis 22.

Next, the operation of the backlight unit 24 according to the present embodiment will be explained. The light emitted from each of the LED light sources 28 enters the optical member 18 directly or indirectly after being reflected by the inclined surface 26a of the reflection member 26. No support pin 27 is provided between the LED light source 28 and the inclined surface 28a encircling the LED light source 28. Accordingly, the light traveling from the LED light source 28 to the inclined surface 26a of the reflection member 26 hardly or is less likely to be blocked by the support pin 27. Thus, in the backlight unit 24, even when the support pin 27 is provided to support the optical member 18, the light emitted from the LED light sources 28 arranged to surround the support pin 27 can be equally led to the optical member side by the reflection member 28. This equalizes the amount of light traveling from each of the LED light sources 28 to the optical member 18. Accordingly, in the backlight unit 24, the uneven brightness on the display surface of the liquid crystal panel 16 can be prevented or suppressed.

In the backlight unit 24, the support pin 27 passes through the top surface potion 26b of the reflection member 26 such that the lower surface 27b of the upper section 27a of the support pin 27 is in contact with the front surface of the top surface portion 26b of the reflection member 26. Accordingly, the deformation or lifting up of the reflection member 26 due to heat generated around the LED light source 28 can be prevented or suppressed by the lower surface 27b of the support pin 27.

As described above, in the backlight unit 24 according to the present embodiment, the support pin 27 arranged between the LED light sources 28 is spaced equally away from each of the LED light sources 28. Accordingly, when the light traveling from the LED light source 28 to the inclined surface 26a of the reflection member 26 is partially blocked by the support pin 27, the light can be equally blocked. Further, the light traveling from the LED light source 28 to the inclined surface 26a of the reflection member 26 is less likely to be blocked by the support pin 27. Thus, in the direct-type backlight unit 24, the uneven brightness that may be caused on the display surface of the liquid crystal panel 16 by the support pin 27 can be prevented or suppressed.

In the backlight unit 24 according to the present embodiment, the support pin 27 is arranged to pass through the reflection member 26. Accordingly, a part of the support pin 27 is covered with the reflection member 26, and thus the light traveling from the LED light source 28 to the inclined surface 26a of the reflection member 26 is less likely to be blocked. This can prevent or suppress the uneven brightness that may be caused on the display surface of the liquid crystal panel 16 by the support pin 27.

In the backlight unit 24 according to the present embodiment, the reflection member 26 has the top surface portion 26b connecting the end portions of adjacent inclined surfaces 26a on the optical member 18 side. The support pin 27 is arranged to pass through the top surface portion 26b. Accordingly, a larger part of the support pin 27 can be covered with the reflection member 26. Thus, the light traveling from the LED light source 28 to the inclined surface 26a of the reflection member 26 is further less likely to be blocked by the support pin 27, and thus the uneven brightness that may be caused on the display panel of the liquid crystal panel 16 by the support pin 27 can be prevented or suppressed.

In the backlight unit 24 according to the present embodiment, the lower surface 27b of the upper section 27a of the support pin 27 is in contact with the surface of the reflection member 26 facing the optical member 18. Accordingly, the lifting up of the reflection member 26 toward the optical member 18 can be prevented or suppressed by the lower surface 27b of the upper section 27a of the support pin 27. This can prevent or suppress the uneven brightness that may be caused on the display surface of the liquid crystal panel 16 by the support pin 27.

In the backlight unit 24 according to the present embodiment, the upper section 27a of the support pin 27 that is positioned on the front side of the reflection member 26 is tapered. Accordingly, the area in which the light emitted from the LED light source 28 may be blocked by the support pin 27 can be smaller. This can prevent or suppress the uneven brightness that may be caused on the display surface of the liquid crystal panel 16 by the support pin 27.

In the backlight unit 24 according to the present embodiment, the support pin 27 passes through the bottom plate 22a of the chassis 22 and is attached to the bottom plate 22a. Thus, the support pin 27 can be stably fixed to the bottom plate 22a of the chassis 22. Accordingly, the uneven brightness that may be caused on the display surface of the liquid crystal panel 16 by the support pin 27 can be effectively prevented or suppressed.

In the backlight unit 24 according to the present embodiment, the reflection member 26 is shaped to encircle each of the LED light sources 28. Accordingly, the light emitted from each LED light source 28 can be effectively led toward the optical member 18 side by the reflection member 26. Thus, the uneven brightness on the display surface of the liquid crystal panel 16 can be further prevented or suppressed.

In the backlight unit 24 according to the present embodiment, adjacent LED light sources 28 are spaced apart from each other at regular intervals. With this configuration, brightness distribution can be more equalized on the light exit side of the LED light source 28. Thus, the uneven brightness on the display surface of the liquid crystal panel 16 can be prevented or suppressed.

### Second Embodiment

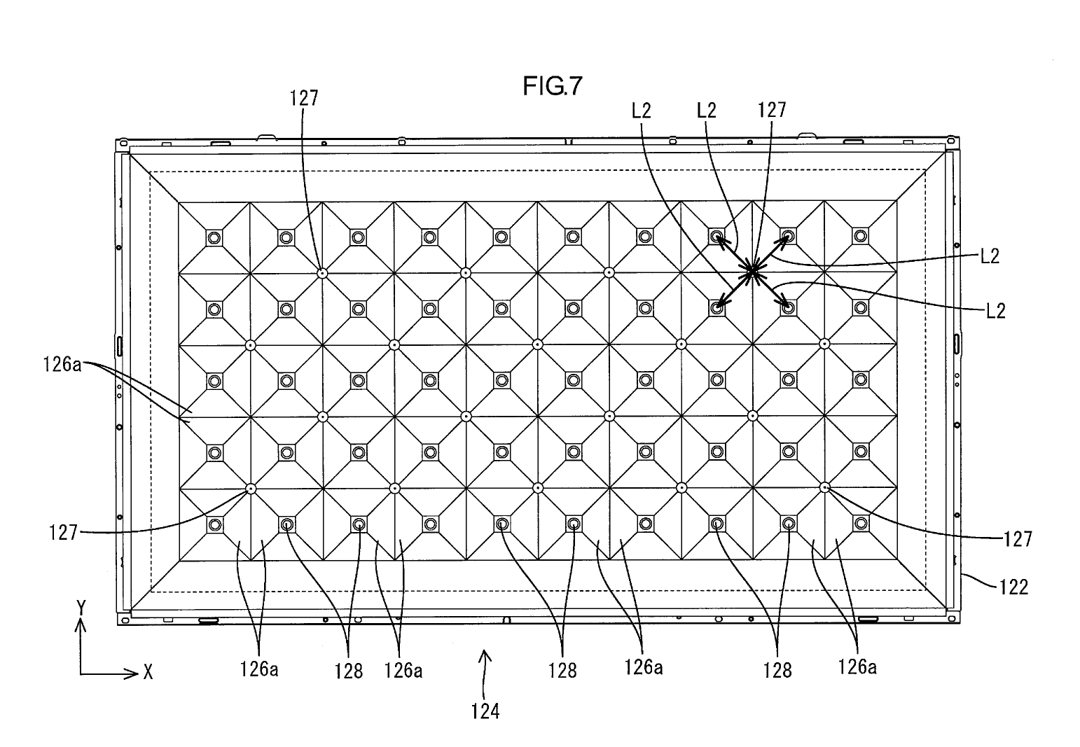

The second embodiment will be explained with reference to the drawings. FIG. 7 illustrates a backlight unit 124 according to the second embodiment in a plan view. The second embodiment differs from the first embodiment in the shape of a reflection member 126. The other structures are same as those of the first embodiment, and thus configurations, functions, and effects similar to those of the first embodiment will not be explained. In FIG. 7, members and portions indicated by the number obtained by adding 100 to the reference numerals in FIG. 3 are the same as the members and the portions explained in the first embodiment.

As illustrated in FIG. 2, in a backlight unit 124 according to the second embodiment, inclined surfaces 126a of a reflection member 126 form an inverted four-sided pyramid and encircle each of LED light sources 128. The inclined surfaces 126a extend in the circumferential direction to form a square shape. Accordingly, each of the LED light sources 128 are encircled by four inclined surfaces 126a inclined from the LED board 130 side to the front side. The inclined surfaces 126a are inclined at the same angle. Distances L2 between the support pin 127 and each of the LED light sources 128 arranged to surround the support pin 127 are the same. In this configuration, the inclined surfaces 126a of the reflection member 126 are shaped in the inverted four-sided pyramid to encircle each LED light source 128. Compared with the case in which each light source 128 is encircled by the inclined surfaces 126a in the inverted conical shape (the case in which the reflection member 26 of the first embodiment is employed), the reflection member 126 can maintain high shape stability.

### Third Embodiment

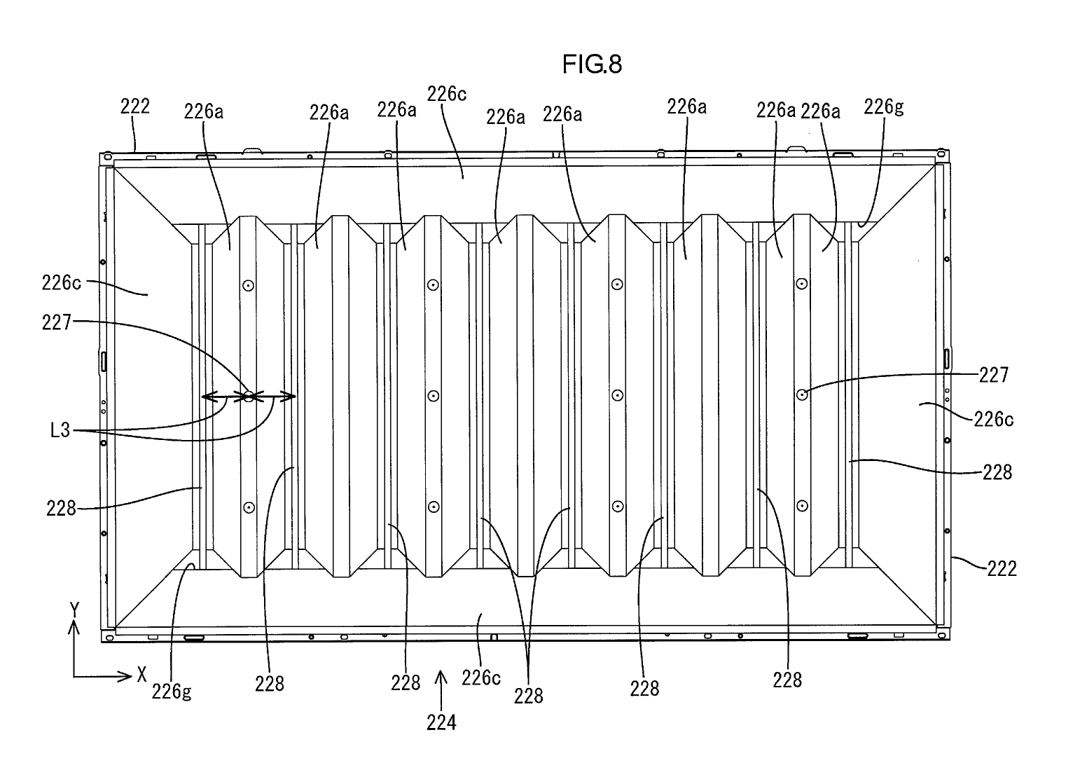

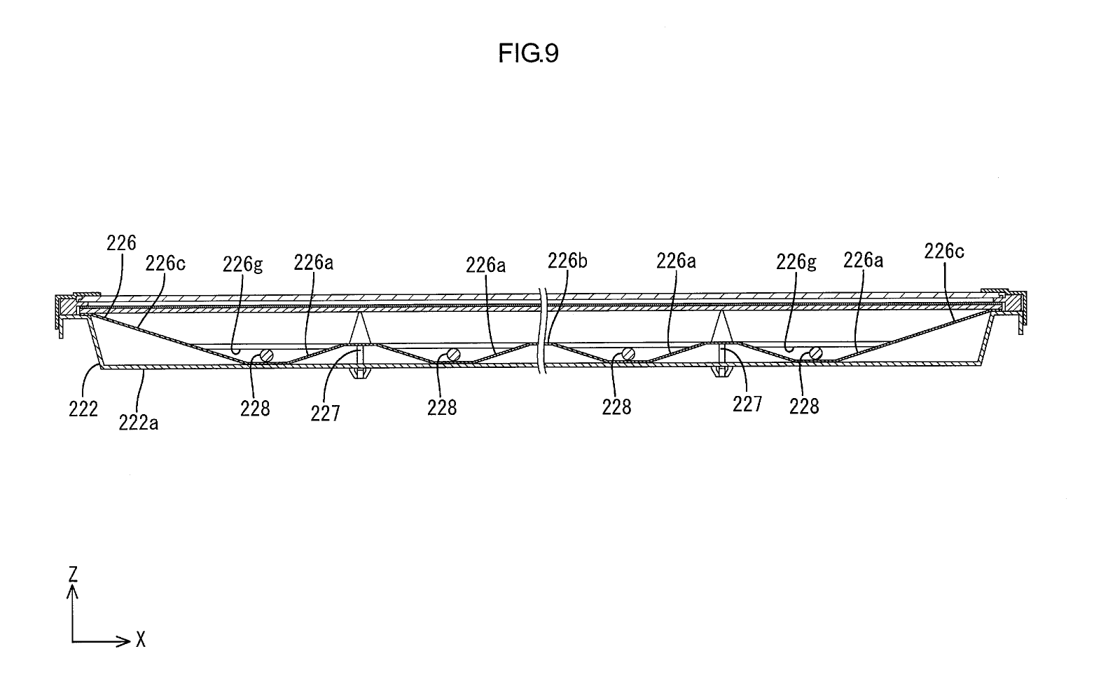

The second embodiment will be explained with reference to the drawings. FIG. 8 illustrates a backlight unit 224 according to the third embodiment in a plan view. FIG. 9 is a cross-sectional view of the backlight unit 224 taken along the horizontal direction. The second embodiment differs from the first embodiment in the shape of the reflection member 226, a kind of light source, and an arrangement of support pins 227. The other structures are same as those of the first embodiment, and thus configurations, functions, and effects similar to those of the first embodiment will not be explained. In FIG. 8 and FIG. 9, members and portions indicated by the number obtained by adding 200 to the reference numerals in FIG. 3 and FIG. 4 are the same as the members and the portions explained in the first embodiment.

In a backlight unit 224 according to the third embodiment, instead of the LED light source, a straight discharge tube 228 is used as a light source. A reflection member 226 is arranged on the front side of a bottom plate 222a of a chassis 222. The reflection member 226 includes flat bottom portions that are in contact with the front surface of the bottom plate 222a of the chassis 222, inclined surfaces 226a that are configured to lead the light to the optical member side, and flat top surface portions 226b. The flat bottom portions, the inclined surfaces 226a, and the flat top surface portions 226b of the reflection member 226 are alternately arranged in the X-axis direction so as to form a wave shape. The inclined surface 226a projects to have a predetermined space between the projected end portion of the inclined surface 226a and the optical member. The inclined surface 226a is not in contact with the optical member. On each of the flat bottom portions of the reflection member 226, the discharge tube 228 is arranged along the Y-axis direction. The reflection member 226 includes four rising portions 226c and four extended portions 226e. The rising portions 26c and the extended portions 226e have the same configurations as those of the reflection member 26 of the first embodiment.

The rising portions 226c of the reflection member 226 arranged along the long side of the chassis 222 each include an insertion opening 226g at positions facing end portions of the discharge tube 228. The insertion opening 226g is larger than a diameter of the discharge tube 228. The end portions of the discharge tube 228 are housed on the rear side of the reflection member 226 and connected to a connector (not illustrated) provided on the bottom plate 22a of the chassis 222.

In the backlight unit 224 according to the third embodiment, support pins 227 are arranged along the Y-axis direction at positions overlapping with each flat top surface portion 226b of the reflection member 226. Each support pin 227 is arranged to pass through the top surface portion 226b of the reflection member 226. Like the support pin 27 of the first embodiment, the tip end of the support pin 227 is in contact with the optical member arranged on the opening side of the chassis 222. Distances L3 between each of the support pins 227 and each of two discharge tubes 228 positioned on both sides of the support pin 227 are the same. Accordingly, in the backlight unit 224 according to the third embodiment, the light traveling from the discharge tube 228 toward the inclined surface 226a of the reflection member 226 hardly or is less likely to be blocked by the support pin 227. Thus, in the backlight unit 224, even when the backlight unit 224 includes the support pin 227, the uneven brightness on the display surface of the liquid crystal panel can be prevented or suppressed.

The configuration of the embodiments correspond to the configuration of the present invention as follows: the LED light source 28, 128, 228 is one example of “light source”; the support pin 27, 127, 227 is one example of “support member”; and the lower surface 27b of the upper section 27a of the support pin 27 is one example of “contact portion”.

The above embodiments may include the following modifications.

(1) In the above embodiments, the support pin includes the upper section having a conical shape and the lower section having the shaft-like shape. However, the configuration of the support pin is not limited to the above.
(2) In the above embodiments, the support pin is attached to the bottom plate of the chassis by bending back the lower end of the lower section of the support pin. However, the support pin may be attached to the bottom plate of the chassis with a fastener, for example.
(3) In the above embodiments, the support pin is attached to the bottom plate of the chassis. However, the support pin may be integrally formed with the bottom plate of the chassis.
(4) The arrangement, configurations, and the like of the support pins are not limited to the above embodiments, and may be suitably changed.
(5) The shape and the like of the reflection member are not limited to the above embodiments, and may be suitably changed.
(6) In the above embodiments, the liquid crystal display device including the liquid crystal panel as a display panel is used. The technology can be applied to display devices including other types of display panels.
(7) In the above embodiments, the television device including the tuner is used. However, the technology can be applied to a display device without a tuner.

The embodiments of the present invention are explained in detail above for illustrative propose only, and it is to be understood that the claims are not limited by the forgoing description. The technology described in the claims includes the various modifications of the embodiments described above.

The technology components described in the description and the drawings are not required to be used in the combination described in the claims as originally filed. The technology components can show its technical utility when used either alone or in combination. In addition, the technology described in the above description and the drawings can achieve more than one object at the same time, and the technical utility of the technology can be recognized when the technology achieves one of the objects.

### EXPLANATION OF SYMBOLS

TV: television device, Ca, Cb: cabinet, T: tuner, S: stand, 10: liquid crystal display device, 12: bezel, 14: frame, 16: liquid crystal panel, 18: optical member, 22, 122, 222: chassis, 22a, 122a, 222a: bottom plate, 24, 124, 224: backlight unit, 26, 126, 226: reflection member, 26a, 126a, 226a: inclined surface, 27, 127, 227: support pin, 28, 128: LED light source, 30: LED board, 228: discharge tube

1. A lighting device comprising:
a chassis including a bottom plate and side plates rising from peripheral edge portions of the bottom plate toward a front side, the chassis having an opening on the front side;
a plurality of light sources housed in the chassis;
an optical member arranged on an opening side of the chassis, light emitted from the light sources passing through the optical member;
a reflection member including a plurality of inclined surfaces inclined from a light source mounting surface on which the light sources are mounted toward the optical member, the inclined surfaces being configured to lead the light emitted from the light sources toward the optical member; and
a support member attached to the bottom plate of the chassis, the support member extending from the light source mounting surface toward the optical member and a tip end of the support member being in contact with the optical member to support the optical member, the support member being positioned between the light sources and spaced equally away from each of the light sources.

2. The lighting device according to claim 1, wherein the support member is arranged to pass through the reflection member.

3. The lighting device according to claim 2, wherein the reflection member has a top surface portion connecting optical-member-side end portions of the inclined surfaces adjacent to each other, and
the support member is arranged to pass through the top surface portion.

4. The lighting device according to claim 2, wherein the support member includes a contact portion that is in contact with a surface of the reflection member facing the optical member.

5. The lighting device according to claim 1, wherein the support member has a tapered shape.

6. The lighting device according to claim 1, wherein the support member is arranged to pass through the bottom plate of the chassis to be attached to the bottom plate.

7. The lighting device according to claim 1, wherein the reflection member has a shape encircling each one of the light sources.

8. The lighting device according to claim 1, wherein the light sources are arranged at regular intervals.

9. A display device comprising:
a display panel configured to provide display using light from the lighting device according to claim 1.

10. The display device according to claim 9, wherein the display panel is a liquid crystal panel using liquid crystals.

11. A television device comprising the display device according to claim 9.
